(19) United States
(12) Patent Application Publication
(10) Pub. No.: US 2007/0267512 A1
(43) Pub. Date: Nov. 22, 2007

(54) System for uniform cold-spray application of high-solid content emulsified asphalts

(76) Inventor: Carl Raabe, Durham, CA (US)

Correspondence Address: STORM LLP, BANK OF AMERICA PLAZA, 901 MAIN STREET, SUITE 7100, DALLAS, TX, 75202, US

(21) Appl. No.: 11/436,910

(22) Filed: May 18, 2006

(51) Int. Cl. A62C 5/02

(52) U.S. Cl. 239/9; 239/422; 239/428; 239/DIG. 8

(57) ABSTRACT

The present invention relates to the atomization of high-solid content fluids. More particularly, the present invention relates to a system [10] and method for the uniform spray application of roofing materials and, in particular, to the uniform spray application of emulsified asphalts and emulsified asphalt matrices with embedded fiberglass strands. In a preferred embodiment, an engine or equivalent power source [20] is provided. An oil pump [40] is mechanically connected to the engine [20]. A hydraulic motor [80] is hydraulically connected to the oil pump [40]. A reciprocating pump [100] is mechanically connected to the hydraulic motor [80]. The reciprocating pump [100] is connected to a one-way valve [120] which is connected in series with a pulsation dampener [130]. The pulsation dampener [130] dampens the pressured spikes of the slurry exiting the reciprocating pump [100].

### TECHNICAL FIELD OF INVENTION

The present invention relates to the spray application of high-solid content slurries. More particularly, the present invention relates to a system and method for the uniform, high-volume cold-spray application of roofing materials and, in particular, to the application of emulsified asphalt and similar compositions containing strengthening solids such as fiberglass, whereas the strengthening solids are mixed into the distribution stream after pumping.

### BACKGROUND OF THE INVENTION

Emulsified asphalt is a mixture of asphalt cement, water and an emulsifying agent. Emulsions are liquid at ambient temperatures. They can be applied at cooler temperatures than asphalt cements and cutback asphalts. Emulsions can be used in place of asphalt cements and cutback asphalts for many applications.

When an emulsion comes in contact with aggregate, it “sets” or “breaks.” This happens because the asphalt droplets react with the aggregate surface squeezing out the water between the aggregate particles. “Breaking” or “setting” also occurs due to evaporation of water from the emulsion.

There are two major categories of emulsion: cationic and anionic. Anionic emulsions have negatively charged asphalt droplets and cationic emulsions have positively charged asphalt droplets. Both anionic and cationic emulsions are further graded according to their “setting” rate: rapid setting, medium setting, and slow setting. The setting rate is controlled by the type and amount of emulsifying agent.

Emulsified asphalt is well known and broadly utilized as a preferred roofing material in industrial and commercial applications. Emulsified asphalt came into general use in the 1920's, mostly for spray applications and use as dust palliatives. Emulsified asphalt provides a highly durable and reliable roofing material for a very reasonable cost. Favorable physical properties include water resistance, load bearing capability, resistance to photo-degradation, thermal stability, and insulating value. Favorable market properties include low cost, energy savings, availability, and installation versatility and simplicity. ASTM D 1227 is an industry standard entitled “Specification for Emulsified Asphalt Used as a Protective Coating for Roofing.”

Conventional emulsified asphalt can be applied by brush, roller, or spray distribution. Spray distribution is the most efficient means of applying asphalt to large areas. Conventional systems for spray application of emulsified asphalt have an engine, an oil pump mechanically connected to the engine, a hydraulic motor hydraulically connected to the oil pump, and a positive displacement reciprocating pump mechanically connected to the hydraulic motor. A hose is connected to the output of the reciprocating pump. A spray nozzle at the end of the hose has a valve for turning the flow on and off.

Presently, there are several commercially available materials for use in cold-spray application of emulsified asphalt to form a seamless composite membrane system. There is only one commercially available material that is generally accepted for use in cold spray application of seamless reinforced composite membrane systems, such as those employing a matrix of fiberglass within the emulsion. That product is HE121 Asphalt Emulsion, available from Henry Company, 2911 Slauson Avenue, Huntington Park, Calif. 90255. The product is made from emulsified asphalt with bentonite clay and water and contains 47% to 53% solids by weight (ASTM D2939).

Spray application of emulsified asphalt requires a powerful pump due to the high viscosity of the slurry. It is well known to employ positive displacement pumps for the transport of petrochemicals. Positive displacement pumps are generally divided into two broad categories, being rotary and reciprocating.

In typical commercial and industrial roofing applications, emulsified asphalt is pumped from buckets or drums by means of a reciprocating pump. The reciprocating pump is typically driven by a hydraulic or pneumatic reciprocating pump. These pumps are readily commercially available. The energy input to drive the reciprocating pump determines the pressure output of the pump. Conversely, establishing a set system operating pressure can establish the required energy input, or engine throttle setting.

Reciprocating pump output is controlled by setting the pressure limit of the hydraulic pump. When the pressure falls below the pressure setting, the speed or rpm of the engine is increased, which increases the system pressure until it reaches the set pressure. Actual volumetric output of the pump is determined by characteristics of the fluid being pumped and the pressure losses in the system encountered while pumping the fluid.

When the pressure limit is exceeded, a bypass valve is opened, allowing the hydraulic fluid to bypass the hydraulic motor, and thus terminating operation of the reciprocating pump. When the spray nozzle valve at the exit point of the hose is closed, the system pressure will exceed the pressure limit and the bypass valve will engage to recirculate the hydraulic oil. This terminates operation of the reciprocating pump. A one-way check valve retains slurry fluid pressure between the closed nozzle valve and the closed check valve. When the nozzle valve is reopened, pressurized slurry immediately exits the nozzle valve. The system pressure is relieved and the bypass valve disengaged. The reciprocating pump begins immediate operation and the system operating pressure is maintained. Because each stroke of the reciprocating pump delivers slurry, the operator has excellent on-off control of the sprayed product at the spray nozzle valve. This is critical to production of a quality cold-spray product.

Cold-spray application of conventional emulsified asphalt requires a volumetric output of the slurry at the delivery point (the spray nozzle) that is substantially less than commercially available systems can readily produce. This permits operation of the reciprocating pump at normal speed and normal pressure. While reciprocating pumps are the most appropriate in size and cost for cold-spray application of emulsified asphalts, they are also characterized by high pulsation output, particularly at higher speeds.

The volumetric capacities of commercially available gas hydraulic reciprocating pumps are generally limited to approximately 15 gallons per minute (depending upon the viscosity and density of the slurry). A pump having this capacity is Graco® Model GH1015 obtainable from Graco, Inc., 88-11^{th} Avenue NE, Minneapolis, Minn. 55413. Very high volume reciprocating pumps are well known, such as those found on drilling rigs, to pump mud. However, these pumps are not readily portable, and far too expensive to be practical for use in any commercial roofing application.

Numerous asphalt-based material improvements are now becoming available, and many of them may benefit from a higher volumetric output during application. Polymer modification has made possible the use of emulsions for techniques not previously considered. Polymer modification of asphalt compounds causes significant changes in the stress-strain behavior, the creep response and the non-Newtonian flow patterns. The ability of some polymers to elastically recover adds durability to asphalt. Improvements in resistance to thermal cracking, fatigue damage, and temperature susceptibility have resulted in wide-spread use of polymer modified binders as a substitute for asphalt in paving and maintenance applications.

As a specific example, acrylic polymer compositions are now available as replacements for asphalt in many applications. Acrylic polymer compositions are also arising as solutions in applications in which asphalt was never an option. As with emulsified asphalts, it is desirable to have higher volume spray distribution capability with many of these materials.

Uniformity of distribution of the emulsified asphalt is critical to the appearance and performance of the composite products. Standardized tests have been established for measurement of uniformity of spray applied asphalt mixed with dry aggregate mass in certain applications. There exists a need to increase the volumetric output while eliminating or substantially decreasing the pulsation during spray application of emulsified asphalts in these and in other applications.

A specific such need arises from recent improvements in the compositions used in roofing and street construction and repair. For example, U.S. Pat. Nos. 3,096,225; 3,212,691; 5,462,764 and 5,468,293; collectively, illustrate a mixture of blended fiberglass strands and emulsified asphalt. In these systems, a spray gun with a cutting assembly cuts fiberglass thread into a plurality of individual strands in the proximity of the spray nozzle. The cut fiberglass threads are sprayed in a path that intersects the path of the emulsified asphalt such that the fiberglass and emulsified asphalt are mixed when applied to the target surface. If properly applied, the resultant matrix will have performance characteristics superior to traditional asphalt.

A significant disadvantage of existing, commercially available pumping systems is that they cannot uniformly coat and distribute the fiberglass strand within the asphalt emulsion, resulting in uneven distribution and inferior appearance and performance of the matrix. Exposed, uncoated strands of fiberglass are considered a defect in the applied product. It has been determined through experimentation that properly blending fiberglass strands with emulsified asphalt requires higher volumetric output (flow rates) combined with significantly lower pulsation than is obtainable from commercially available reciprocating pumps.

Several attempts have been made to increase the flow rate capability of existing spray distribution systems for emulsified asphalts. Larger volume reciprocating pumps that are readily portable are not presently commercially available. Manufacturers recognize the associated cost of building the large pumps would make the product cost prohibitively expensive for contractors engaged in the roofing and asphalt business. In addition to the significant increase in the cost of the pumps, contractors must pay for the increased engine size, oil pumps, and hydraulic motors necessary to operate the larger pumps. Still, the requirement remains, and other solutions have been sought.

One attempt to provide increased flow rates of emulsified asphalt has been to use rotary screw pumps, or auger pumps. Auger pumps are well known in the application of hot asphalt compositions. Auger pumps are capable of generating significantly higher flow rates than commercially available reciprocating pumps, and deliver a continuous pulsation-free flow. A significant disadvantage of these pumps is that they cannot be started and stopped in the same manner as reciprocating pumps. The effect is that the operator has less control over the sprayed distribution, and the final product quality is significantly inferior in appearance. This is why auger pumps are not preferred, and rarely used in the roofing industry.

The system that is now commercially accepted and most frequently employed to resolve the volumetric flow problem is the use of dual reciprocating pumps configured in parallel relation. In this configuration, two commercially available pumps can be used to increase the flow rate. Typically, this also requires the use of two reciprocating motors, one for each of the pumps. A common engine or power source can be used to operate the motors. To prevent surging of the pumps, operators attempt to stagger the stroke positions of the pumps. The disadvantage of this system is that operators cannot adequately control or sustain sequenced cycling operation of the pumps, since the pumps are mechanically independent. The result is that the pumps will cycle in and out of phase, frequently cycling together and causing a pulsating, surging output.

Another problem with developing solutions to the current problem of high volume flow rates is that emulsified asphalt is messy to work with and, when hardened, is generally inflexible. As a result, conventional equipment employed to work with other spray applied substances, such as paint, cannot be readily used in the spray application of emulsified asphalt. As the asphalt dries on or inside the equipment after application, it clogs, stiffens, or otherwise incapacitates commercially available paint spraying equipment. For example, application of conventional surge suppression systems relying on highly flexible internal rubberized diaphragm components are not used in the roofing industry, or composite application industry, since it is impractical to disassemble such equipment for cleaning after each use.

It can thus be seen that there is a need to develop a system and method for the application of high-solid content emulsified asphalt compositions at high volume flow rates without surging. There is also a need to provide such a system utilizing affordable and commercially available equipment. There is also a need for developing such a system that is resistant to disablement by the use and/or curing of the asphalt.

### SUMMARY OF THE INVENTION

A primary advantage of the present invention is that it provides a means for uniform spray application of a reinforcing material (such as cut fiberglass strands) thoroughly coated with an emulsified asphalt. Another advantage of the present invention is that it provides a means for spray application of high-solid content emulsified asphalt at higher flow rates in a manner that creates a more uniform surface coating. Another advantage of the present invention is that it is adapted to be retrofit to existing systems and to commercially available equipment. Another advantage of the present invention is that it is relatively inexpensive.

Other advantages of the present invention will become apparent from the following descriptions, taken in connection with the accompanying drawings, wherein, by way of illustration and example, an embodiment of the present invention is disclosed. As referred to herein, the “present invention” refers to one or more embodiments of the present invention which may or may not be claimed, and such references are not intended to limit the language of the claims, or to be used to construe the claims in a limiting manner.

In accordance with one aspect of the invention, there is provided a system for uniform cold-spray application of high-solid content emulsified asphalts, which comprises a reciprocating pump having a pump inlet and a pump outlet. A one-way valve is pipe connected to the pump outlet. A pulsation dampener is pipe connected to the outlet of the one-way valve. In a more preferred embodiment, the pulsation dampener is nitrogen filled.

In another preferred embodiment, a method for spray application of an emulsified asphalt is disclosed comprising the steps of: a) pumping emulsified asphalt with a reciprocating pump into a pulsation dampener; b) emitting the emulsified asphalt through a nozzle attached to a hose, which is attached to the pulsation dampener; and c) sealing the dampener outlet upon completion of the spray application.

In another preferred embodiment, a method for spray application of a fiberglass reinforced emulsified asphalt matrix is disclosed, comprising the steps of: a) pumping emulsified asphalt with a reciprocating pump into a pulsation dampener; b) emitting the emulsified asphalt through a nozzle attached to a hose, attached to the pulsation dampener; c) cutting a plurality of strands of fiberglass; and d) spraying the strands onto the target surface coincident with the emitted emulsified asphalt so that the strands are commingled and coated with the emulsified asphalt prior to striking a target surface.

In another preferred embodiment, an apparatus for spray application of a fiberglass reinforced emulsified asphalt matrix is disclosed, comprising a pumping means for pumping emulsified asphalt, a dampening means for reducing pulsation of the pumped emulsified asphalt, a cutting means for causing a thread of fiberglass into strands, and a spray means for causing the cut strands to flow into a path coincident with the flow of the emulsified asphalt.

In another preferred embodiment, the output of the dampening means is sealed from air by a valve or cap.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a system for uniform cold-spray application of emulsified asphalt containing strengthening solids such as fiberglass strands, illustrated in accordance with a preferred embodiment of the present invention.

FIG. 2 is a side view of a pumping system illustrated in accordance with a preferred embodiment of the present invention, shown in a portable configuration.

FIG. 3 is a side view of the pumping system disclosed in FIG. 2, shown in a platform configuration.

FIG. 4 is an end view of the preferred embodiment disclosed in FIG. 3.

FIG. 5 is an exploded break-out view of the connections between a reciprocating pump and discharge pulsation dampener of the present invention.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

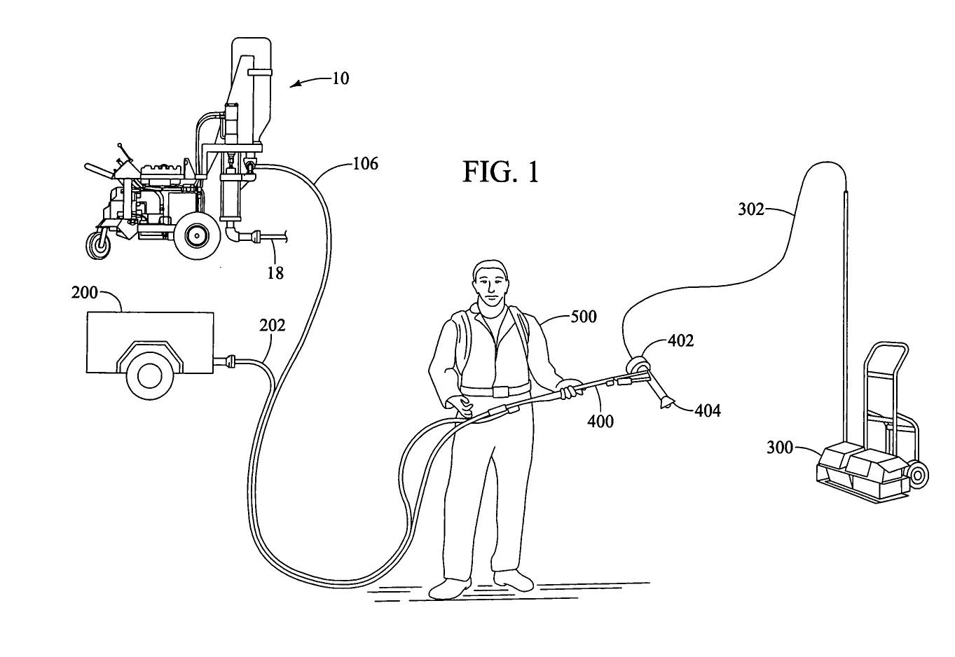

FIG. 1 is an isometric view of a system for uniform cold-spray application of emulsified asphalt containing strengthening solids such as fiberglass, illustrated in accordance with a preferred embodiment of the present invention. Application system 10 is shown connected for operation to supply and delivery components. Application system 10 is connected to an emulsified asphalt supply through input hose 18. Application system 10 pumps a high volume of emulsified asphalt in a uniform flow through an output hose 106 to an applicator gun 400.

A compressed air source 200 supplies compressed air through an air hose 202 to applicator gun 400. A supply source 300 of reinforcing strand 302 material is delivered to a strand cutter 402. Applicator gun 400 is manually operated by an operator 500.

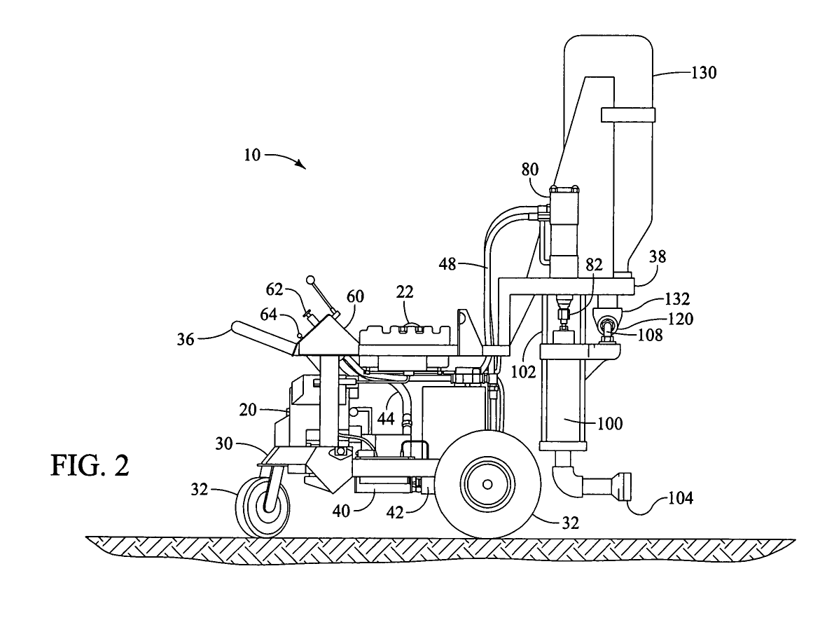

FIG. 2 is a side view of application system 10, illustrated in accordance with a preferred embodiment of the present invention, shown in a portable configuration. A power supply 20 is provided as a power source. In the embodiment illustrated, power supply 20 is a gasoline powered engine. For this requirement, an industrial engine such as a Kohler™ Model CH18 OHV 4 cycle engine may be used. A tank 22 stores fuel for power supply 20.

In the portable embodiment illustrated, power supply 20 is mounted on a frame 30, which is supported on wheels 32. A handle 36 may be included to facilitate movement and relocation of application system 10.

Power supply 20 is mechanically connected to a gear hydraulic pump 40. A tank 42 stores oil for hydraulic pump 40. A hydraulic connection 44 connects hydraulic pump 40 to a metering system 46 (not shown). Metering system 46 is controllable by the operator through a control panel 60. A valve 62 at control panel 60 permits adjustment of the pressure output of hydraulic pump 40.

A hydraulic connection 48 connects metering system 46 to a linear hydraulic motor 80. Hydraulic motor 80 is attached to frame 30 by a mounting bracket 38. A piston assembly 82 mechanically connects hydraulic motor 80 to a positive displacement reciprocating pump 100. In the preferred embodiment, reciprocating pump 100 has a flow rate capability of 15 gallons per minute. In another preferred embodiment, reciprocating pump 100 has at least a 1000 psi maximum operating pressure. For this requirement, a reciprocating pump such as a Graco® GH1015 may be used.

Reciprocating pump 100 is attached to frame 30 by means of mounting bracket 38. Reciprocating pump 100 is attached to mounting bracket 38 by support studs 102. Reciprocating pump 100 has a pump inlet 104. Pump inlet 104 is connectable to a supply line (not shown) for suction from a supply of emulsified asphalt material. Reciprocating pump 100 has a pump outlet casting 108. A pipe connection 112 connects pump outlet 108 to a valve inlet 122 of a one-way valve 120. One-way valve 120 has a valve outlet 124.

Referring to FIG. 4, a pipe connection 126 connects valve outlet 124 of one-way valve 120 to a dampener inlet 132 of a high-volume discharge pulsation dampener 130. In the preferred embodiment, dampener 130 has at least a 5 gallon capacity and at least a 3000 psi maximum operating pressure.

In another preferred embodiment, dampener 130 is nitrogen filled and has a Viton® rubber bladder. The Viton® rubber resists chemical deterioration when exposed to the asphalt emulsions. For this requirement, a discharge pulsation dampener such as Model 5.O AS-3000V from Young Engineering Manufacturing, Inc.™, 560 W. Terrace Drive, San Dimas, Calif. 91773, may be used. Pulsation dampener 130 has a dampener outlet 134. Dampener outlet 134 is connectable to a hose 106 (see FIG. 1) for delivery of emulsified asphalt.

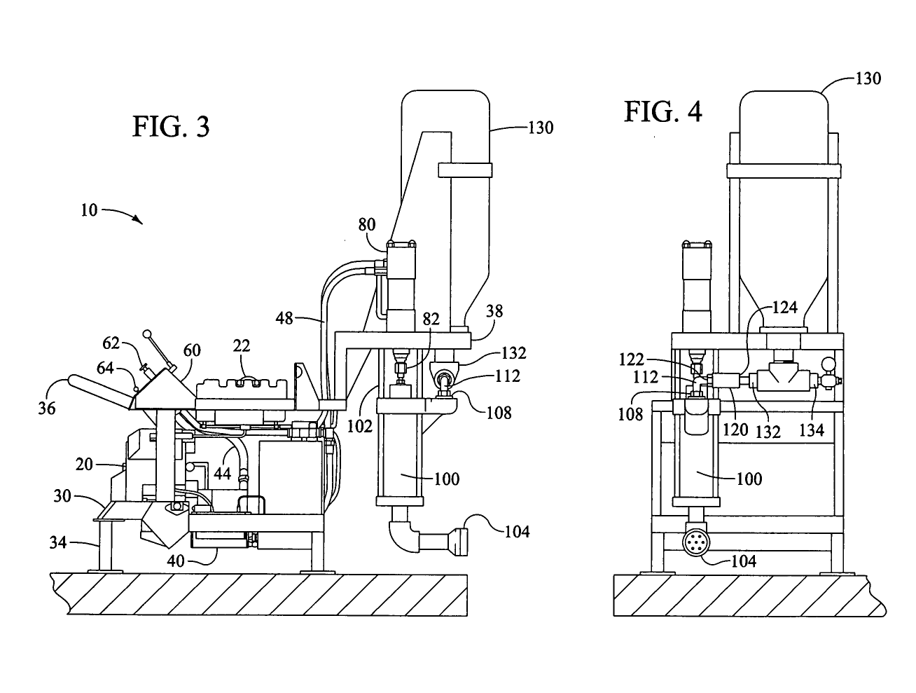

FIG. 3 is a side view of application system 10 as disclosed in FIG. 2, except that it is shown in a platform configuration. In this embodiment, frame 30 is supported on legs 34.

FIG. 4 is an end view of application system 10 as disclosed in FIG. 3. In this view, the connection between reciprocating pump 100, one-way valve 120 and pulsation dampener 130 are visible.

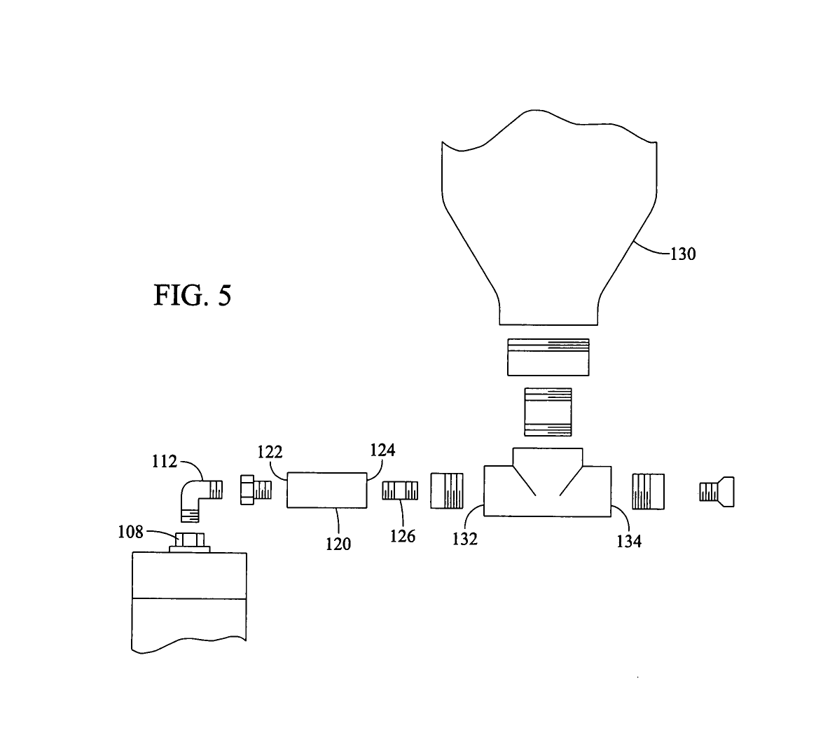

FIG. 5 is an exploded break-out view of the connections between reciprocating pump 100 and discharge pulsation dampener 130 of application system 10.

In an alternative embodiment, power supply 20 and hydraulic pump 40 can be replaced by a compressed air source. In this alternative embodiment, hydraulic motor 80 is likewise replaced with a pneumatic motor.

### Operation of the Preferred Embodiments

In a preferred embodiment, compressed air from a compressed air source 200 is supplied to an applicator gun 400. The compressed air provides power to feed reinforcing strand 302 from a supply source 300 through applicator gun 400. Reinforcing strand 302 is cut into strands by strand cutter 402 and discharged through nozzle 404.

Also in the preferred embodiment, application system 10 pumps a high volume of emulsified asphalt in a uniform flow through output hose 106 to applicator gun 400. The emulsified asphalt is discharged through nozzle 404 of applicator gun 400.

During operation, pulsation dampener 130 compensates for the mechanical deficiencies normally experienced when using reciprocating pump 100 for high-volume spray applications of emulsified asphalts. This is critical when combining the emulsified asphalt with a reinforcing strand 302 such as fiberglass.

The applicator gun 400 is manually operated by an operator 500. The emulsified asphalt is sprayed out of nozzle 404 in a uniform manner that thoroughly commingles the shredded pieces of reinforcing strand 302 with the emulsified asphalt, allowing the strands 302 to be properly coated with the emulsified asphalt before reaching the target surface upon which application of the asphalt composite matrix is desired. Thus applied, the reinforced asphalt provides a final product having substantially improved strength, durability and aesthetic appeal.

Curing of emulsified asphalt is initiated by exposure to air and ultraviolet light. The cure rate is significantly dependent upon exposure to air. By preventing air exposure to the internal components of pulsation dampener 130, damage to the flexible bladder inside pulsation dampener 130 can be prevented, or delayed. This can be accomplished by removing output hose 106 after use, and capping or plugging dampener outlet 134. In an alternative embodiment, a closable valve, such as a ball valve, can be located between dampener outlet 134 and output hose 106.

It will be readily apparent to those skilled in the art that the general principles defined herein may be applied to other embodiments and applications without departing from the spirit and scope of the present invention.

I claim:

1. A system for spray application of an emulsified asphalt comprising:
a hydraulic motor;
a reciprocating pump mechanically connected to the motor, and having a pump inlet and a pump outlet;
a one-way valve having a valve inlet and a valve outlet, the valve inlet being pipe connected to the pump outlet;
a pulsation dampener having a dampener inlet and a dampener outlet, the dampener inlet being pipe connected to the valve outlet;
a hose connected at one end to the dampener outlet; and
a nozzle connected to the opposite end of the delivery hose.

2. The system of claim 1, further comprising:
the reciprocating pump having a flow rate capability of 15 gallon per minute.

3. The system of claim 1, further comprising:
the reciprocating pump having a maximum operating pressure of at least 1000 pounds per square inch.

4. The system of claim 1, further comprising:
the dampener having at least a 5 gallon capacity.

5. The system of claim 1, further comprising:
the dampener having a maximum operating pressure of at least 3000 pounds per square inch.

6. The system of claim 1, further comprising:
the dampener being nitrogen filled and having a Viton® rubber bladder.

7. The system of claim 1, further comprising:
a value connected to the dampener outlet.

8. A method for spray application of a strand reinforced emulsified asphalt matrix on a targeted surface, comprising the steps of:
a) pumping emulsified asphalt with a reciprocating pump into a dampener inlet of a nitrogen filled pulsation dampener;
b) emitting the emulsified asphalt through an outlet hose, attached to an outlet of the pulsation dampener;
c) delivering the emulsified asphalt to an applicator gun connected to the output hose;
d) delivering compressed air to the applicator gun;
e) delivering a continuous strand of reinforcing material to the applicator gun;
f) cutting the strand and spraying the cut strands out of the applicator gun;
g) spraying the emulsified asphalt so that the strands are commingled with the emulsified asphalt prior to striking the targeted surface.

9. The method of spray application of claim 8, further comprising the step of sealing the dampener outlet upon completion of the spray application.

10. An apparatus for spray application of a strand reinforced emulsified asphalt matrix, comprising:
a pumping means for pumping emulsified asphalt;
a dampening means for reducing pulsation of the pumped emulsified asphalt;
a cutting means for causing a thread of fiberglass into strands; and
a spray means for causing the cut strands to flow into a path coincident with the flow of the emulsified asphalt.
